(19) United States
(12) Patent Application Publication
(10) Pub. No.: US 2026/0146172 A1
(43) Pub. Date: May 28, 2026

(54) SILICONE RUBBER EMULSION COATING

(71) Applicant: Performance Chemicals, LLC, Franklin, NH (US)

(72) Inventors: Michael Robert CURRIER, Gilford, NH (US); Matthew Michael CURRIER, Gilford, NH (US); Robert Thorton CURRIER, Canterbury, NH (US)

(21) Appl. No.: 19/114,582

(22) PCT Filed: Jun. 5, 2023
(86) PCT No.: PCT/US2023/067914

§ 371 Date: Mar. 24, 2025

(51) Int. Cl. C09D 7/80; C08G 77/08; C08J 3/05; C08J 3/24; C09D 5/02; C09D 5/18; C09D 183/04

(52) U.S. Cl. CPC C09D 7/80; C08G 77/08; C08J 3/05; C08J 3/24; C09D 5/027; C09D 5/185; C09D 183/04; C08J 2383/06; C08J 2427/18

(57) ABSTRACT

The system and method for a water-based dispersion of silicone rubber and catalyst for use as a coating. The coating is useful on a wide variety of surfaces and may contain polytetrafluoroethylene (PTFE) and/or ammonium polyphosphate. The silicone rubber emulsion coatings have several notable features. First, it is dilutable with water, thus eliminating hazardous solvents and cosolvents. Second, it has low volatility. Third, it is not a fire or VOC hazard. Fourth, it forms an elastomeric film on a wide range of substrates. Fifth, it is easily applied using a spray, roll, coating, or brush.

### CROSS REFERENCE TO RELATED APPLICATIONS

This application claims the benefit of PCT/US23/67914, filed Jun. 5, 2023, and to U.S. Provisional Patent Application No. 63/413,034, filed Oct. 4, 2022, the content of each of which is incorporated by reference herein in its entirety.

### FIELD OF THE DISCLOSURE

The present disclosure relates to protective coatings and more particularly to a silicone rubber emulsion coating for use on a variety of surfaces to provide a variety of benefits including water repellency, soil resistance, flame retardance, and restoration of worn surfaces to original or better than new performance.

### BACKGROUND OF THE DISCLOSURE

Current protective coatings contain solvents or co-solvents. In some cases, they are two-part systems. In some cases, they are a based on an unreacted silicone fluid or the like. Current one-part coatings incorporate amine functional silicone, acrylics, urethanes, and/or polyaspartic additives that reduce product performance and long-term UV stability and suffer yellowing and chalking when exposed to the environment. Other existing coatings comprised of amine functional materials degrade in UV and have very poor adhesion and recoatability. Existing coatings have poor bonding; poor coating to substrate, and subsequent poor coating to coating bonding. Existing two-part formulations containing silicone rubber and a catalyst have reduced use times before polymerization and are too viscous to be rolled, sprayed, or flood coated, and are difficult and inconsistent in use.

In many cases, existing solutions have co-solvents (e.g., volatile organic compounds (VOC)); substances of very high concern (SVHC); PROP 65 materials; which are not Registration, Evaluation, Authorization and Restriction of Chemicals (REACH) compliant (e.g., nonylphenol ethoxylates); or contain catalysts which are not environmentally green and are themselves SVHC. Current systems often incorporate additives like silica to add bonding strength to substrates, but these additions generate inconsistency of the bonding of the coating to the substrate. Existing systems do not have tear strengths nor elongation values suited for long term durability during cold and hot expansion, for example. And, when under impact the systems often fail from coating damage. Additionally, existing systems are not well suited for tinting to produce custom colors and often leave a hazed coating unsuitable for coating on glass substrates. Many current systems have inferior bonding to steel, wood, paper, asphalt, ethylene propylene diamine monomer (EPDM) rubber, aggregate shingles, concrete, plastics, and fiberglass. Existing systems do not improve wind resistance of the substrate and offer little benefit for high-speed wind shear.

Wherefore it is an object of the present disclosure to overcome the above-mentioned shortcomings and drawbacks associated with conventional protective coatings.

### SUMMARY OF THE DISCLOSURE

It has been recognized that there is a need for a water based liquid silicone rubber emulsion that is ecologically responsible, which is recoatable and has adhesion to organic and inorganic substrates with improved properties.

One general aspect includes a method of making a silicone coating. The method also includes emulsifying a silicone polymer into an aqueous solution to form a silicone emulsion; emulsifying an organometallic fatty acid catalyst and surfactants to form a catalytic emulsion; and mixing the silicone emulsion and the catalytic emulsion to form a silicone dispersion, where the silicone dispersion has a particle size of about 0.5-7 microns.

Implementations may include one or more of the following features. The method where the silicone polymer is hydroxyl polydimethylsiloxane. The organometallic fatty acid catalyst is an organotin fatty acid salt. The surfactants are nonylphenol surfactants and the aqueous solution may include water, oh functional silicone polymer, and non-ionic surfactants. The method may include blending the silicone dispersion with a polytetrafluoroethylene (PTFE) dispersion. The method may include applying the silicone dispersion to a substrate. The method may include cross-linking the silicone dispersion in ambient air to form a silicone rubber emulsion coating on the substrate. The substate is one or more of an organic or an inorganic substrate. The method may include adding an ammonium polyphosphate to the dispersion to form a silicone rubber emulsion coating having flame resistant intumescent properties.

One general aspect includes a silicone coating. The silicone also includes a first component may include a silicone polymer in an aqueous emulsion. The silicone also includes a second component may include an organometallic fatty acid catalyst and surfactants; where the first and second component each have a particle size of about 0.5-5 microns and when the first and second component are mixed, form a dispersion that is cross-linkable in air when applied to a substrate.

Implementations may include one or more of the following features. The coating may include a third component may include a polytetrafluoroethylene (PTFE) dispersion. The silicone polymer is hydroxyl polydimethylsiloxane and the organometallic fatty acid catalyst is an organotin fatty acid salt. The hydroxyl polydimethylsiloxane emulsified in water is at about 2-50% wt/wt and has a fluid viscosity of about 30-250 cSt. The organotin fatty acid salts is at about 5% wt/wt. The surfactants are selected from the group may include of non-ionic family of C12-C14-secondary etholoxates, polyethlene glycol, dimethylmethyl (polyethylene oxide), and silicone trimethyl-terminated. The aqueous solution may include water, OH functional silicone polymer, and non-ionic surfactants.

One general aspect includes a method of using a silicone coating. The method also includes applying a dispersion to a substrate, the dispersion may include a silicone polymer in an aqueous emulsion and an organometallic fatty acid catalyst and surfactants. The method also includes cross-linking the dispersion in ambient air to form a silicone rubber emulsion coating. The method also includes where the dispersion has a particle size of about 0.5-7 microns, a nonvolatile content of about 1%-50% wt/wt; a pH in a range of about 3.5-6.5; a viscosity (mPa*s) in a range of about 1.0-10,000.

Implementations may include one or more of the following features. The method where the cross-linked silicone rubber emulsion coating has a hardness in a range of about 50-67 N/mm², a tensile strength in a range of about 2.0-10 MPa; and an elongation in a range of about 100%-1000%. The silicone polymer is hydroxyl polydimethylsiloxane and the organometallic fatty acid catalyst is an organotin fatty acid salt.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows one implementation of a method of making a silicone rubber emulsion coating according to the principles of the present disclosure.

FIG. 2 shows one implementation of a method of using a silicone rubber emulsion coating according to the principles of the present disclosure.

### DETAILED DESCRIPTION OF THE DISCLOSURE

One implementation of the silicone rubber emulsion coating of the present disclosure is up to about 50% solids micro emulsion of a functional elastomeric rubber silicone containing a polytetrafluoroethylene (PTFE) polymer and a catalyst. In certain implementations, a range of water is about 60% to 80%, thus about 20-40% total solids. The coatings of the present disclosure are useful on a wide variety of substrates, including, but not limited to, concrete/stucco, building wall surfaces, painted surfaces, asphalt, ceramic roof shingles, and the like. In certain implementations, the silicone rubber emulsion of the present disclosure is used as a roof coating. In other implementations, the coating is applied to plywood, oriented strand board (OSB), or the like to give a single monolayer surface for new roof structures. In yet other implementations, the coatings may also be applied as decorative wall coatings for commercial and residential surfaces. The coatings of the present disclosure provide exceptional water, soil, and oil repellency and are economical and easy-to-handle emulsions which may be diluted with water to relatively low concentrations while cross-linking ambiently to orient the PTFE. This eliminates the need for solvents or co-solvents to orient the PTFE to achieve oil repellency.

In certain implementations, after the evaporation of water, the silicone rubber emulsion coating of the present disclosure will ambiently and/or with the application of heat form an elastomeric film which will adhere aggressively to most surfaces. Certain implementations of the coatings of the present disclosure may be flame resistant or fireproof. In some implementations, PTFE is blended with the silicone rubber emulsion coating in a 1:1 relationship (e.g., a blend of the “coating” at a 30% total solids level, and a PTFE dispersion also at a 30% solids level) to add extreme oil repellency. In some cases, the viscosity of the liquid coating is modified for use in different application systems (e.g., spray, roll, or flood coating). In certain implementations, the coatings are tintable allowing a custom color palette range, while maintaining performance specifications. In certain implementations, a black base layer is applied, then an aggregate color layer is applied, followed by a topcoat.

One implementation of the coating of the present disclosure is an emulsifier comprising silicone glycol and a tridecyl alcohol blend used as a Tin catalyst emulsion such that the emulsifier degrades upon evaporation making the catalyst reactive and begins cross linking. One implementation of the silicone rubber emulsion coating of the present disclosure uses an emulsifier for a base silicone rubber fluid comprising a secondary alcohol ethoxylate and silicone glycol copolymer, and a nonionic surfactant which is readily biodegradable and is non-alkylphenols and their ethoxylates (APE) based.

In one implementation, the silicone rubber emulsion coating of the present disclosure is formed as a two-part system. In one implementation, Part 1 comprises an organometallic catalyst (e.g., Tin/Zinc, Tin, Zinc) at about 1-20% wt/wt and surfactants at about 1-5% wt/wt. In some cases, a Zinc catalyst is used. In certain implementations, a nonylphenol type surfactant is used. In one implementation, Part 2 comprises a silicone rubber fluid with OH functionality at about 1-50% wt/wt, and surfactant levels at about 1-10% wt/wt, dispersed on a colloid mill type disperser (e.g., rotor stator). In one implementation of the silicone rubber emulsion coating of the present disclosure, Part 1 and Part 2 are blended together for about 30 minutes yielding: a nonvolatile content of about 1%-50% wt/wt (at about 105° C./3 h) that is dilution dependent. In one implementation, the blended composition has a pH in a range of about 4.0-7.5; a Viscosity (mPa*s) in a range of about 1.0-10,000. In one implementation, the resulting cross-linked film has a hardness in a range of about 50-67 N/mm², a tensile strength in a range of about 2.0-10 MPa; and an elongation in a range of about 100%-1000%. In certain implementations, the time it takes for the applied coating to cross-link and harden is directly dependent to the evaporation of the water phase and dependent to the level of solids in the applied mix. Thus, the higher the total solids present in the emulsion the faster the water will flash off upon evaporation.

In one implementation of the silicone rubber emulsion coating of the present disclosure, the liquid (pre-cross-linked) coating has an about 40.1% wt/wt nonvolatile content with surfactants of about 5% wt/wt. One implementation has a target pH of about 4.7, a target viscosity of about 10.4 cSt. In certain cases, the liquid coating is further thickened per customer requirements. In one implementation, the cross-linked coating has a target hardness of about 63 N/mm², a target tensile strength of about 5.2 MPa, within a range of tensile strength of about 4.8-5.8. In one implementation, the target elongation is 670%, within a range of elongation of about 600-700%.

In another implementation of a silicone rubber emulsion coating formed as a two-part system, Part 1: comprises hydroxyl polydimethylsiloxane at about 2-50% wt/wt with a fluid viscosity of about 30-250 cSt emulsified into water. In some cases, about 0.5% wt/wt poly(ethylene oxide), about 4% wt/wt alcohols (e.g., C12-C14-secondary etholoxates), about 1% wt/wt polyethlene glycol, about 2% wt/wt dimethylmethyl (polyethylene oxide), about 0.5% wt/wt silicone trimethyl-terminated, and about 0.5% wt/wt dipropylene glycol monomethyl/ether are added. In one implementation, Part 2: comprises about 5% wt/wt organo tin fatty acid salts, about 0.5% wt/wt poly(ethylene oxide), about 4% wt/wt alcohols (e.g., C12-C14-secondary etholoxates), about 1% wt/wt polyethlene glycol, about 2% wt/wt dimethylmethyl (polyethylene oxide), about 0.5% wt/wt silicone trimethyl-terminated, and about 0.5% wt/wt dipropylene glycol monomethyl/ether.

In one implementation, Part 1 and Part 2 are emulsified individually via a rotor stator disperser, or the like, to achieve a particle size of about 0.5-7 microns each. In certain implementations, Part 1 and Part 2 are then blended together to form a uniform dispersion that cures, or cross-links, upon air drying. There, the surfactants are evaporated with the water to allow the catalyst and OH silicone polymer to react to form a silicone rubber emulsion coating. In one implementation, the surfactants include nonylphenols and nonylphenol ethoxylates, or nonionic surfactants (aka detergent-like substances).

Properties of an exemplary implementation of the silicone rubber emulsion coating of the present disclosure are shown in Table 1, below:

TABLE 1

| PROPERTY | VALUE | UNIT |
|---|---|---|
| Appearance: | Tintable white liquid | — |
| Percent of active solids: | 5.0-50 | % |
| Tensile strength: | 2.0 min | (MPa) |
| Elongation: | 700 max | % |
| Tear strength: | 9.8 | (kN/m) |
| pH: | 4.0-7.5 | — |
| wt/gallon: | 8.42-9.17 | Lb/gal |
| Specific gravity | 1.01-1.1 | |

Components of exemplary implementations of the silicone rubber emulsion coating of the present disclosure are shown in Table 2 and Table 3, below:

TABLE 2

| Component | % wt/wt |
|---|---|
| Hydroxyl polydimethylsiloxane | 2-75 |
| Poly(ethylene oxide) | 0.5-5.0 |
| Alcohols (e.g., c12-c14-secondary etholoxates) | 2-12 |
| Polyethylene glycol | 1-6 |
| Dimethyl methyl (polyethylene oxide) | 2-8 |
| Silicone trimethyl-terminated | 0.5-4.0 |
| Dipropylene glycol monomethyl/ether | 0.5-4.0 |
| Organometallic fatty acid salts (e.g., tin, zinc) | 1-20 |
| Alkylbenzene sulfonic acid salts | 0.5-4.0 |

TABLE 3

| Component | % wt/wt |
|---|---|
| Hydroxyl polydimethylsiloxane | 2-50 |
| Poly(ethylene oxide) | 1-3.5 |
| Alcohols (e.g., c12-c14-secondary etholoxates) | 2-10 |
| Polyethylene glycol | 2-4.5 |
| Dimethyl methyl (polyethylene oxide) | 2-6 |
| Silicone trimethyl-terminated | 0.5-3.0 |
| Dipropylene glycol monomethyl/ether | 0.5-3.0 |
| Organometallic fatty acid salts (e.g., tin, zinc) | 4-6 |
| Alkylbenzene sulfonic acid salts | 0.5-3.0 |

Implementations of the silicone rubber emulsion coating of the present disclosure are perfluorooctanoic acid (PFOA) free, polyfluoroalkyl substances (PFAS) free, VOC free, and nonyl phenol free while having exceptional adhesion to asphalt, EPDM, concrete surfaces, and the like due in part to the OH sites present within the rubber emulsion as it is air or heat cross-linked, due to OH and Si bonding. Implementations of the coating disclosed herein offer recoatability, which has not previously been achieved. Certain implementations of the present disclosure are tintable and colored using liquid dye or pigment dispersions, or the like, to provide a custom-colored finish as desired per individual taste. Certain implementations of the present disclosure comprise an aggregate finish to add a custom color or to restore an existing color on a worn substrate from the addition of adding aggregate into the coating to provide a custom-colored finish as desired per individual taste. Certain implementations of the present disclosure apply an aggregate finish to an uncoated surface e.g., wood, concrete, steel, aluminum, etc., to add a custom color or to restore and existing color on a worn substrate from the addition of adding aggregate into the coating to provide a custom-colored finish as desired per individual taste.

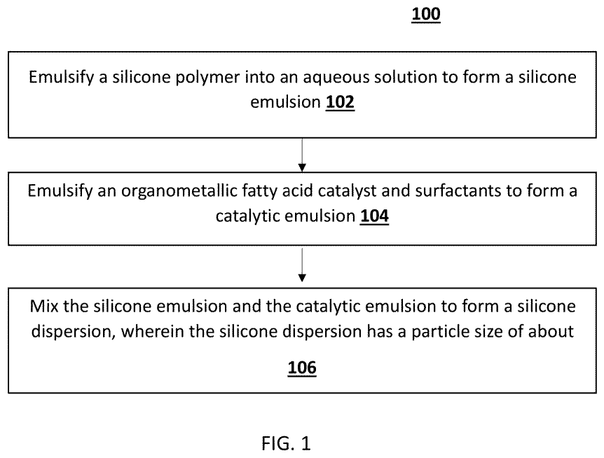

Referring to FIG. 1, one implementation of a method of making a silicone coating 100 is shown. More specifically, a silicone polymer is emulsified into an aqueous solution to form a silicone emulsion 102. An organometallic fatty acid catalyst and surfactants are emulsified to form a catalytic emulsion 104. The silicone emulsion and the catalytic emulsion are mixed to form a silicone dispersion 106, wherein the silicone dispersion has a particle size of about 0.5-7 microns.

Implementations of the coating of the present disclosure may be applied to a new roof substrate or to a worn roof substrate that is installed to improve performance and weatherability and mitigate further aggregate loss due to shingle degradation. Implementations of the silicone rubber emulsion coating of the present disclosure bond with shingle substrates to form a single uniform roof structure and enable windstorm resistance above 150 MPH by mitigating the lifting of individual shingles during high wind. In one implementation, product testing was to 230 MPH without failure.

Certain implementations of the coatings of the present disclosure repel ice, mitigate ice dam build up, reduce icicle formation and build up on the edges of coated roofs. Certain implementations of the coatings of the present disclosure prevent a treated roof from being wetted out from driving rain, thus mitigating buildup of mold, moss, bird feces, and the like. In some implementations of the silicone rubber emulsion coating of the present disclosure, the coating does not degrade when exposed to UV providing a life span of the coating of about 30 years.

Certain implementations of the silicone rubber emulsion coating of the present disclosure are diluted for application. In some implementations, the water hardness used for dilution should be less than about 200 ppm hardness to maintain maximum dilution stability. In certain implementations the dilutions range is from about 45% total solids to about 1% total solids depending on the desired application. In some cases, softened, DI water or boiler condensate is recommended as a diluent.

In some implementations, when diluting the emulsion with water to lower the concentration of silicone, additional bacteriostat and/or fungistat may be used to mitigate waterborne microbial activity in the dilution water. In certain implementations, corrosion inhibitors are used if the emulsion may come in contact with steel containers or aerosol cans. In certain implementations, the addition of about 0.1% sodium benzoate may be used for this purpose. In one implementation, dilution of the silicone rubber emulsion coating of the present disclosure resulted in about a 20-22% total solids with a 2-100 mil coating thickness when applied.

In certain implementations, the coating is applied onto acrylic painted surfaces over concrete, wood, and vinyl, onto concrete and virgin brick and block surfaces, and the like. Implementations of the silicone rubber emulsion coating of the present disclosure are useful for several applications. First, as a coating for rubber, plastic, glass, concrete, metal, paper products, etc. Second, as a durable self “curing” coating. Third, as a tire, leather, vinyl, and rubber dressing. Fourth, as a textile softener and thread lubricant. Fifth, as a paint and concrete/masonry additive and metal coating to add hydrostatic properties to concrete to keep water from impregnating the concrete and degrading from water exposure. Sixth, as a coating for fiberglass and fiberglass non-wovens to give a flexible finish that will be hydrophobic and oleophobic. Seventh, as a steel, painted steel and galvanized steel coating to reduce the oxidation from water, brine and resistance to chipping from debris strikes. Eight, as a door seal coating to give anti squeak properties; to reduce noise, vibration, and harshness (NVH); and as a coating to improve abrasion resistance to reduce wear to paint and seals due to the release properties with or without the flame-resistant performance.

Implementations of the silicone rubber emulsion coating of the present disclosure have a cross-linked film thickness of about 1 to about 100 microns. In some implementations, a target thickness for asphalt roofing is about 2 microns, and for commercial flat roofing about 100 microns in a flood coating application. In some implementations, a target thickness for vertical coatings is about 1 micron.

Implementations of the silicone rubber emulsion coating of the present disclosure have a number of notable features. First, it is dilutable with water, thus eliminating hazardous solvents and co-solvents. Second, it has low volatility. Third, it is not a fire or VOC hazard. Fourth, it forms an elastomeric film on a wide range of substrates. Fifth, it is easily applied using a spray, roll, coating, or brush. Sixth, it may be coated and colored for subsequent applications.

In certain implementations of the silicone rubber emulsion coating of the present disclosure, the viscosity is achieved by using an alkali swellable acrylic thickening polymer neutralized with a sodium or potassium hydroxide. In certain implementations, a viscosity range is about 1 cSt for vertical surfaces when sprayed, pad or brushed/rolled to about 100,000 cSt for flood coatings. In certain implementations, a target viscosity range is about 400-600 cSt for standard asphalt shingles roof when sprayed then brushed/roll coated.

One implementation of the coating of the present disclosure as a dried film, when exposed to water or rain, will wash off the surfactant system within the coating as in the wet emulsion uncross-linked phase to provide hydrophobic coating properties. These properties further improve with water and UV exposure over time.

Certain implementations of the coatings of the present disclosure are flame resistant as coated. In some cases, when exposed to high temperatures and ember/open flames, the coatings intumescent properties form a carbon layer protecting the treated surfaces from combustion. In certain implementations, an ammonium polyphosphate (APP) is used. APP is able to function as a flame retardant in the condensed or polymer phase through intumescence. During intumescence, a material swells when it is exposed to heat or fire to form a porous carbonaceous foam which acts as a barrier to prevent heat, air and pyrolysis product from entering the surface of the material.

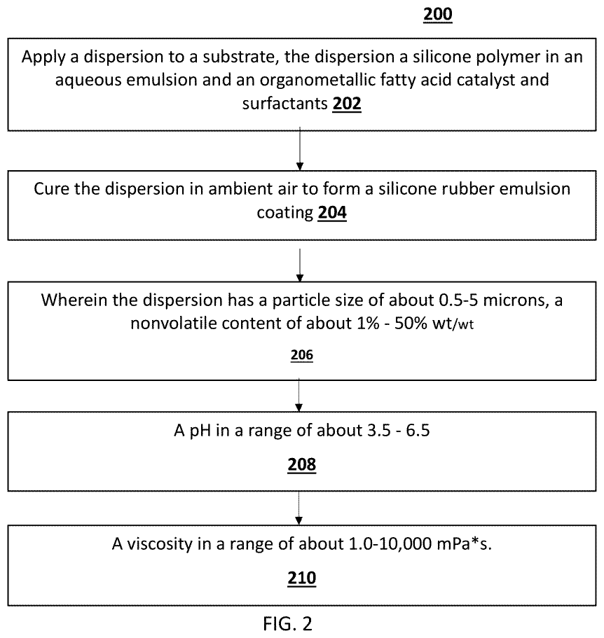

Referring to FIG. 2, one implementation of a method of using a silicone coating 200 is shown. More specifically, a dispersion is applied to a substrate 202, the dispersion comprising a silicone polymer in an aqueous emulsion and an organometallic fatty acid catalyst and surfactants. The dispersion is cured, or cross-linked, in ambient air to form a silicone rubber emulsion coating 204. In certain implementations, the dispersion has a particle size of about 0.5-7 microns, and a nonvolatile content of about 1%-50% wt/wt 206. In certain implementations, the dispersion has a pH in a range of about 3.5-6.5 208. In some cases, the dispersion has a viscosity in a range of about 1.0-10,000 mPa*s 210.

Various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An implementation is an implementation or example of the present disclosure. Reference in the specification to “an implementation,” “one implementation,” “some implementations,” “one particular implementation,” “an exemplary implementation,” or “other implementations,” or the like, means that a particular feature, structure, or characteristic described in connection with the implementations is included in at least some implementations, but not necessarily all implementations, of the invention. The various appearances “an implementation,” “one implementation,” “some implementations,” “one particular implementation,” “an exemplary implementation,” or “other implementations,” or the like, are not necessarily all referring to the same implementations.

If this specification states a component, feature, structure, or characteristic “may”, “might”, or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various implementations of the disclosure are examples and the disclosure is not limited to the exact details shown or described.

What is claimed:

1. A method of making a silicone coating, comprising:
emulsifying a silicone polymer into an aqueous solution to form a silicone emulsion;
emulsifying an organometallic fatty acid catalyst and surfactants to form a catalytic emulsion; and
mixing the silicone emulsion and the catalytic emulsion to form a silicone dispersion, wherein the silicone dispersion has a particle size of about 0.5-7 microns.

2. The method according to claim 1, wherein the silicone polymer is hydroxyl polydimethylsiloxane.

3. The method according to claim 1, wherein the organometallic fatty acid catalyst is an organotin fatty acid salt.

4. The method according to claim 1, wherein the surfactants are nonylphenol surfactants and the aqueous solution comprises water, OH functional silicone polymer, and non-ionic surfactants.

5. The method according to claim 1, further comprising blending the silicone dispersion with a polytetrafluoroethylene (PTFE) dispersion.

6. The method according to claim 1, further comprising applying the silicone dispersion to a substrate.

7. The method according to claim 6, further comprising cross-linking the silicone dispersion in ambient air to form a silicone rubber emulsion coating on the substrate.

8. The method according to claim 1, further comprising adding an ammonium polyphosphate to the silicone dispersion to form a silicone rubber emulsion coating having flame resistant intumescent properties.

9. A silicone coating, comprising:
a first component comprising a silicone polymer in an aqueous emulsion; and
a second component comprising an organometallic fatty acid catalyst and surfactants;
wherein the first and second component each have a particle size of about 0.5-7 microns and when the first and second component are mixed, form a silicone dispersion that is cross-linkable in air when applied to a substrate.

10. The coating according to claim 9, further comprising a third component comprising a polytetrafluoroethylene (PTFE) dispersion.

11. The coating according to claim 9, wherein the silicone polymer is hydroxyl polydimethylsiloxane and the organometallic fatty acid catalyst is an organotin fatty acid salt.

12. The coating according to claim 9, wherein the surfactants are one or more of non-ionic family of C12-C14-secondary etholoxates, polyethlene glycol, dimethylmethyl (polyethylene oxide), and silicone trimethyl-terminated.

13. The coating according to claim 9, wherein the aqueous solution comprises water, OH functional silicone polymer, and non-ionic surfactants.

14. The coating according to claim 11, wherein the hydroxyl polydimethylsiloxane emulsified in water is at about 2-50% wt/wt and has a fluid viscosity of about 30-250 cSt.

15. The coating according to claim 11, wherein the organotin fatty acid salts is at about 5% wt/wt.

16. A method of using a silicone coating, comprising:
applying a silicone dispersion to a substrate, the silicone dispersion comprising a silicone polymer in an aqueous emulsion and an organometallic fatty acid catalyst and surfactants; and
cross-linking the silicone dispersion in ambient air to form a silicone rubber emulsion coating;
wherein the silicone dispersion has a particle size of about 0.5-5 microns, a nonvolatile content of about 1%-50% wt/wt; a pH in a range of about 3.5-6.5; a viscosity in a range of about 1.0-10,000 mPa*s.

17. The method according to claim 16, wherein a cross-linked silicone rubber emulsion coating has a hardness in a range of about 50-67 N/mm², a tensile strength in a range of about 2.0-10 MPa; and an elongation in a range of about 100%-1000%.

18. The method according to claim 16, wherein the silicone polymer is hydroxyl polydimethylsiloxane and the organometallic fatty acid catalyst is an organotin fatty acid salt.

19. The method according to claim 16, where the silicone dispersion further comprises a polytetrafluoroethylene (PTFE) dispersion.

20. The method according to claim 16, further comprising adding an ammonium polyphosphate to the silicone dispersion to form a silicone rubber emulsion coating having flame resistant intumescent properties.
